(19) United States
(12) Patent Application Publication
(10) Pub. No.: US 2011/0083099 A1
(43) Pub. Date: Apr. 7, 2011

(54) MOBILE DEVICE AND OVERLAY DISPLAY METHOD THEREOF

(75) Inventor: Jung Hwi EUN, Seoul (KR)

(73) Assignee: SAMSUNG ELECTRONICS CO. LTD., Suwon-si (KR)

(21) Appl. No.: 12/874,596

(22) Filed: Sep. 2, 2010

(30) Foreign Application Priority Data
Oct. 5, 2009 (KR) 10-2009-0094285

(51) Int. Cl. G06F 3/048

(52) U.S. Cl. 715/786; 715/788

(57) ABSTRACT

A mobile device and method for displaying content in overlay form are provided. To remove user's inconvenience due to limitations on the size of a display unit, the mobile device outputs a first portion of content in a display unit and simultaneously outputs a second portion of the content or other content linked to the content in a floating window selectively offered on the display unit in overlay form.

### PRIORITY

This application claims the benefit under 35 U.S.C. §119(a) of a Korean patent application filed on Oct. 5, 2009 in the Korean Intellectual Property Office and assigned Serial No. 10-2009-0094285, the entire disclosure of which is hereby incorporated by reference.

### BACKGROUND OF THE INVENTION

1. Field of the Invention

The present invention relates in general to a mobile device. More particularly, the present invention relates to a mobile device and method for displaying content in overlay form.

2. Description of the Related Art

With the remarkable growth of related technologies, mobile devices today provide a variety of optional and useful functions in addition to their traditional communication functions, including message transmission, a camera, audio/video reproduction, a digital broadcasting service, an e-mail service, an instant messenger service, and the like.

Mobile devices may, however, fail to offer a sufficient amount of information at a time on the screen due to limitations on the size of a display unit in view of portability. A user who wishes to see portions of content not currently being displayed on the screen has to perform a scroll or a page shift. For example, while writing a reply to a received message or e-mail, the user may often need to frequently scroll or shift a displayed page in order to see the received message or e-mail. Additionally, when displaying a web page with a relatively higher screen resolution, the user may have much trouble in scrolling a partially displayed web page.

### SUMMARY OF THE INVENTION

An aspect of the present invention is to address at least the above-mentioned problems and/or disadvantages and to provide at least the advantages described below. Accordingly, an aspect of the present invention is to provide the above-mentioned problems and/or disadvantages and to offer at least the advantages described below.

An aspect of the present invention is to provide a mobile device and method for displaying content in which a portion of such content not outputted in a display unit is instead outputted in a floating window offered on the display unit in overlay form.

Another aspect of the present invention is to provide a mobile device and method for displaying content in which other content linked thereto is also outputted in a floating window offered on the display unit in overlay form.

In accordance with an aspect of the present invention, a method for displaying content in a mobile device is provided. The method includes outputting a first portion of the content in a display unit, and simultaneously outputting a second portion of the content or other content linked to the content in a floating window selectively offered on the display unit in overlay form.

In accordance with another aspect of the present invention, a mobile device is provided. The device includes a display unit for displaying a first portion of content, and a control unit for outputting the first portion of the content in the display unit and for simultaneously outputting a second portion of the content or other content linked to the content in a floating window selectively offered on the display unit in overlay form.

In accordance with another aspect of the present invention, a method of displaying content in a mobile device is provided. The method includes receiving first content, displaying the first content on a display unit of the mobile device, and simultaneously with the display of the first content, displaying second content in an overlay window overlaying the first content, wherein the second content is a portion of the first content not otherwise displayed on the display unit, or is content related to the first content.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram schematically illustrating the configuration of a mobile device according to an exemplary embodiment of the present invention.

FIG. 2 is a flow diagram illustrating a method for displaying a reply page to a received message in a mobile device according to an exemplary embodiment of the present invention.

FIG. 3 shows example screen views illustrating a method for displaying a reply page to a received message in a mobile device according to an exemplary embodiment of the present invention.

FIG. 4 is a flow diagram illustrating a method for displaying a reply page to a received e-mail in a mobile device according to an exemplary embodiment of the present invention.

FIG. 5 shows example screen views illustrating a method for displaying a reply page to a received e-mail in a mobile device according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the present invention. Accordingly, it should be apparent to those skilled in the art that the following description of exemplary embodiments of the present invention are provided for illustration purpose only and not for the purpose of limiting the present invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In order to address problems of inconvenience caused because a mobile device normally fails to display a sufficient amount of information at a time on the screen due to limitations on the size of a display unit, exemplary embodiments of the present invention provide a mobile device that outputs a portion of content in a display unit and simultaneously outputs another portion of the content or other content in a floating window on the display unit in overlay form.

Although reply pages to a received message and a received e-mail are used hereinafter as examples of content, this is exemplary only. Exemplary embodiments of the present invention may be alternatively applied to a web page with a relatively higher screen resolution by outputting a non-displayed portion of the web page in a floating window. Additionally, exemplary embodiments of the present invention may be applied to a document edit by outputting a preceding or following page in a floating window, or to an instant messenger service by outputting another chat room or the past dialog of a current chat room in a floating window.

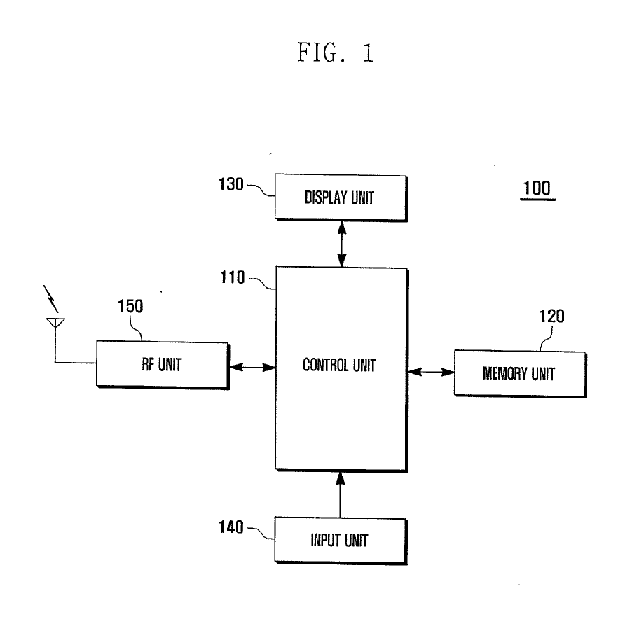

FIG. 1 is a block diagram schematically illustrating the configuration of a mobile device according to an exemplary embodiment of the present invention.

Referring to FIG. 1, the mobile device 100 includes a control unit 110, a memory unit 120, a display unit 130, an input unit 140, and a Radio Frequency (RF) unit 150. According to an exemplary embodiment of the present invention, the mobile device may include additional units. Similarly, the functionality of two or more of the above units may be integrated into a single device.

The RF unit 150 transmits and receives voice signals in connection with a call function and data required for a data communication under the control of the control unit 110. Normally the RF unit 150 may include a duplexer, an RF transmitter, and an RF receiver. The RF transmitter upwardly converts the frequency of outgoing signals received from the control unit 110 and then amplifies the outgoing signals. The RF receiver amplifies incoming signals with low-noise and downwardly converts the frequency of the incoming signals. The duplexer isolates the RF receiver from the RF transmitter. The RF unit 150 may transmit and receive an e-mail, a Short Message Service (SMS), a Multimedia Messaging Service (MMS), an instant messenger message, a web page, a document, and the like.

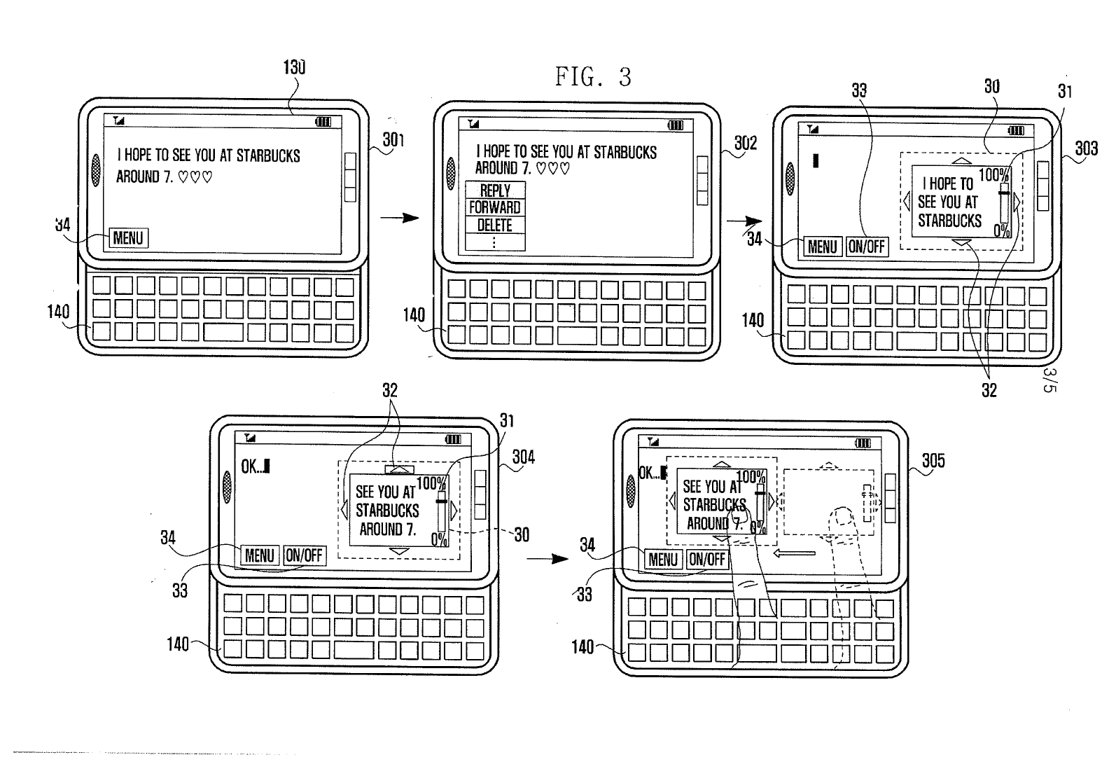

The display unit 130 displays a variety of information on a screen in association with the operation of the mobile device 100 and a user's input manipulation. For example, the display unit 130 may output an initial page in a booting state, a main page in an idle state, various menu pages, video images in a video call, a document edit page, and the like. The display unit 130 may output a reply page to a received message or e-mail and also output an original page of the received message or e-mail in a floating window offered thereon in overlay form. Related description will be given below in detail with reference to FIG. 3. Normally the display unit 130 may be formed of a Liquid Crystal Display (LCD), an Organic Light Emitting Device (OLED), or any other equivalents. In an exemplary implementation, the display unit 130 may be formed of a touch screen which acts together as the input unit 140.

The input unit 140 includes a plurality of normal input keys and special function keys which are configured to receive the user's instructions. For example, the input unit 140 may include a dialing key for making a call, a video call key, an end call key, a volume key for adjusting the output volume of audio signals, navigation keys in at least four directions, and the like. The input unit 140 may also include function keys for on/off, movement, transparency adjustment, scroll, etc. of a floating window. The input unit 140 may be formed of one or a combination of a touch pad, a touch screen, a normal keypad, a qwerty keypad, and any other suitable function keys.

The memory unit 120 stores a variety of applications required for an operating system or optional functions of the mobile device 100, such as sound output, image view, video play, and broadcast reception, as well as related user data. For example, the memory unit 120 may store a web page access program, a document edit program, an instant messenger program, an e-mail program, and the like. In addition, the memory unit 120 may store received e-mails, documents, messages, and the like. The memory unit 120 may store an application for controlling on/off, movement, transparency adjustment, scroll, etc. of a floating window. The memory unit 120 may also store a conversion program for converting an original e-mail or message into a suitable format for a floating window with a relatively smaller size. The conversion program may perform at least one of a thumbnail creation, a font size modification, and a rearrangement of content to be outputted in the floating window.

The control unit 110 controls the whole operation of the mobile device 100 and the flow of signals between internal function blocks. The control unit 110 may control the display unit 130 so as to output a reply page in the display unit 130 when receiving a user's request for a reply to a received message. The control unit 110 may control the display unit 130 so as to offer a floating window on the display unit 130 in overlay form and then output an original page of the received message in the floating window. As will be discussed later, the floating window may have a scroll key for moving a screen view in the floating window, and a transparency adjust bar for changing the transparency of the floating window. In addition, the control unit 110 may control the display unit 130 so as to output an on/off key for controlling the on/off of the floating window in the display unit 130. The control unit 110 may control on/off, movement, transparency adjustment, and scroll of the floating window, depending on an input signal received from the input unit 140. For example, when the display unit 130 is formed of a touch screen, the control unit 110 may move the floating window in response to a user's touch and drag action on the floating window in arbitrary directions. The control unit 110 may also move the floating window in response to a navigation key signal from the input unit 140 after receiving instructions to move the floating window.

The control unit 110 may adjust the transparency of the floating window. After the floating window is selected, the control unit 110 may increase the transparency in response to a volume-up key signal and decrease the transparency in response to a volume-down key signal. When the display unit 130 is formed of a touch screen, the control unit 110 may adjust the transparency of the floating window according to a drag signal from a transparency adjust bar.

The control unit 110 may scroll a screen view in the floating window, depending on a scroll key signal. The control unit 110 may scroll a screen view in the floating window in response to a navigation key signal received from the input unit 140 after the floating window is selected. When the display unit 130 is formed of a touch screen, the control unit 110 may scroll a screen view in the floating window in response to a touch selection of arrow-like scroll keys with four directions contained in the floating window.

The control unit 110 may activate or deactivate the floating window, depending on an on/off control signal for the floating window. This on/off signal may be produced in response to a touch toggle of an on/off button offered on the display unit 130 formed of a touch screen. The on/off signal may also be produced in response to a press of a given function key of the input unit 140.

Although an exemplary embodiment is described above with respect to a reply to a received message, this is exemplary only. Exemplary embodiments of the present invention may be applied to a reply to a received e-mail or any other kind of message, to web pages, to documents, or to chatting.

As indicated above, the mobile device 100 may further include, but is not limited to, additional units, including a camera module, a short distance communication module such as a Bluetooth module, a broadcast receiving module such as a DMB module, a digital sound play module such as an MP3 module, an Internet access module, and the like.

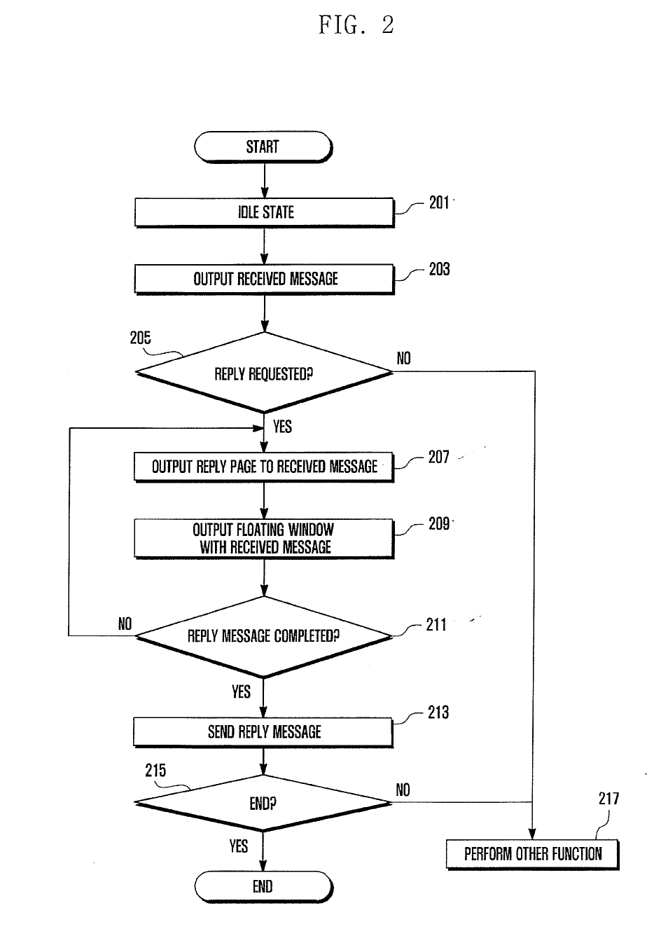

A method for displaying content in a mobile device according to an exemplary embodiment of the present invention will be described in detail with reference to FIGS. 2 to 5.

FIG. 2 is a flow diagram illustrating a method for displaying a reply page to a received message in a mobile device according to an exemplary embodiment of the present invention, and FIG. 3 shows example screen views related to the method shown in FIG. 2.

Referring to FIG. 2 and FIG. 3, the mobile device 100 is available for a landscape mode (i.e., a widthwise view mode), has the input unit 140 with a qwerty key layout, and has the display unit 130 formed of a touch screen as shown in FIG. 3. Exemplary embodiments of the present invention are, however, not limited to the example shown in FIG. 3. The mobile device 100 may be available only for a portrait mode (i.e., a lengthwise view mode), may have another input unit 140 with another key layout, and may have the display unit 130 without allowing touch sensitivity. The mobile device 100 may have various types including, but not limited to, a slide type, a folder type, or a bar type.

The control unit 110 is in an idle state in step 201. The control unit 110 outputs a received SMS message (hereinafter, also referred to as an original message) in the display unit 130 in response to a given input signal (e.g., a selection signal of a specific received message in a message menu) from the input unit 140 in step 203, or upon receipt of the SMS message. For example, the display unit 130 may display an original message thereon as shown in an example screen view 301 in FIG. 3. The display unit 130 may further display a menu key 34 for selecting sub-menus thereon.

The control unit 110 determines whether there is a request for a reply to the original message in step 205. If there is no request for a reply, the control unit 110 may perform another requested or predefined function in step 217. For example, the control unit 110 may delete the original message when receiving a delete command for the original message through the menu key 34, or output a new page for inputting user information (e.g., a phone number) of a recipient when receiving a forward command.

If there is a request for a reply in step 205, the control unit 110 outputs a reply page to a received message in the display unit 130 in step 207 and also outputs a floating window 30 containing the original message on the reply page in overlay form in step 209. The control unit 110 may convert the original message into a suitable format for the floating window 30 with a relatively smaller size. For example, the control unit 110 may perform at least one of a font size modification and a rearrangement of the original message via a conversion program stored in the memory unit 120.

Referring to FIG. 3, when a reply menu is selected through the menu key 34 in a page of the original message as shown in an example screen view 302, the control unit 110 outputs a reply page to a received message in the display unit 130 and also outputs a floating window 30 containing the original message on the reply page in overlay form as shown in an example screen view 303.

Referring to the example screen view 303, the floating window 30 may have a transparency adjust bar 31 for changing the transparency of the floating window 30, and scroll keys 32 for moving a screen view in the floating window 30. Additionally, an on/off key 33 for controlling the display of the floating window 30, together with the menu key 34, may be displayed in the display unit 130.

The user may scroll a screen view in the floating window 30 through the arrow-like scroll keys 32 with four directions. For example, if the upper scroll key 32 is touched as shown in an example screen view 304, the control unit 110 may move the original message upward. As shown in an example screen view 305, the control unit 110 may move the floating window 30 in response to a touch and drag signal in a specific direction. Although not illustrated, the control unit 110 may also adjust the transparency of the floating window 30 in response to a drag signal received from the transparency adjust bar 31. For example, the control unit 110 may decrease the transparency of the floating window 30 as the transparency adjust bar 31 approaches 0%, and increase the transparency as the bar 31 approaches 100%. The control unit 110 may control the activation or deactivation of the floating window 30 in response to a signal of the on/off key 33. For example, the control unit 110 may remove the floating window 30 from the display unit 130 in response to a touch toggle of the on/off key 33 while the floating window 30 is displayed, and also output the floating window 30 in the display unit 130 in response to a touch toggle of the on/off key 33 while the floating window 30 is not displayed.

Returning to FIG. 2, the control unit 110 determines whether a signal indicating the completion of a reply message is received from the input unit 140 in step 211. If there is no completion signal, the control unit 110 may return to step 207. If a completion signal for a reply message is received from the input unit 140, the control unit 110 sends the reply message to a recipient, namely a sender of the original message, through the RF unit 150 in step 213.

The control unit 110 determines whether a signal indicating the end of a message menu is received from the input unit 140 in step 215. If there is no end signal, the control unit 110 may perform another requested or predefined function in step 217. For example, the control unit 110 may output a list of received messages and then, depending on a user's selection, delete a received message from the list or output a new reply page to a received message. If an end signal for a message menu is received from the input unit 140, the control unit 110 ends the message menu and returns to an idle state.

As discussed heretofore, exemplary embodiments of the present invention allow the mobile device to output a received original message in the floating window offered in overlay form on a page for writing a reply message, so that a user can easily write a reply message while seeing a received original message.

A method for displaying content in a mobile device according to an exemplary embodiment of this invention will be described in detail.

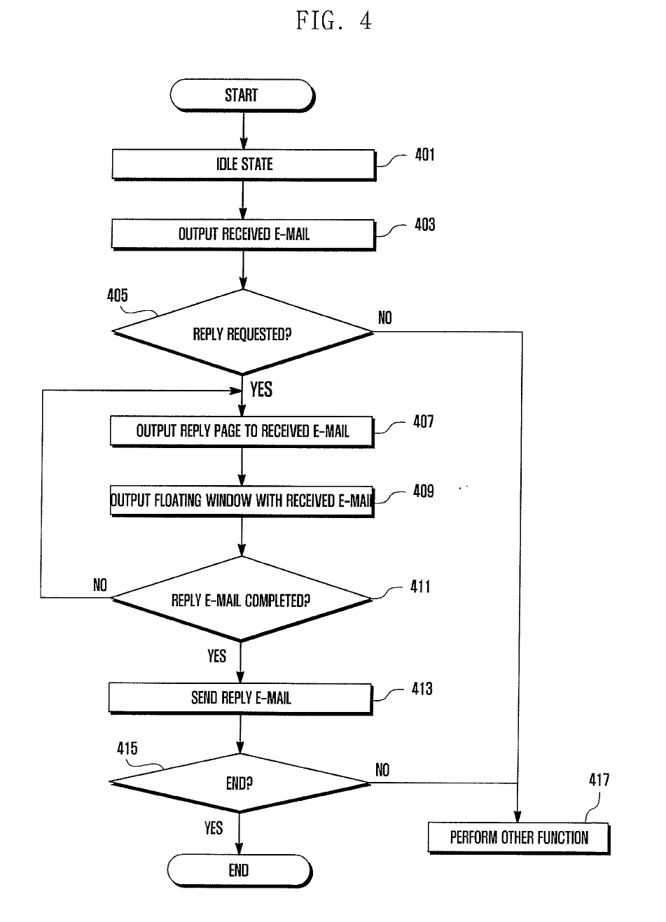

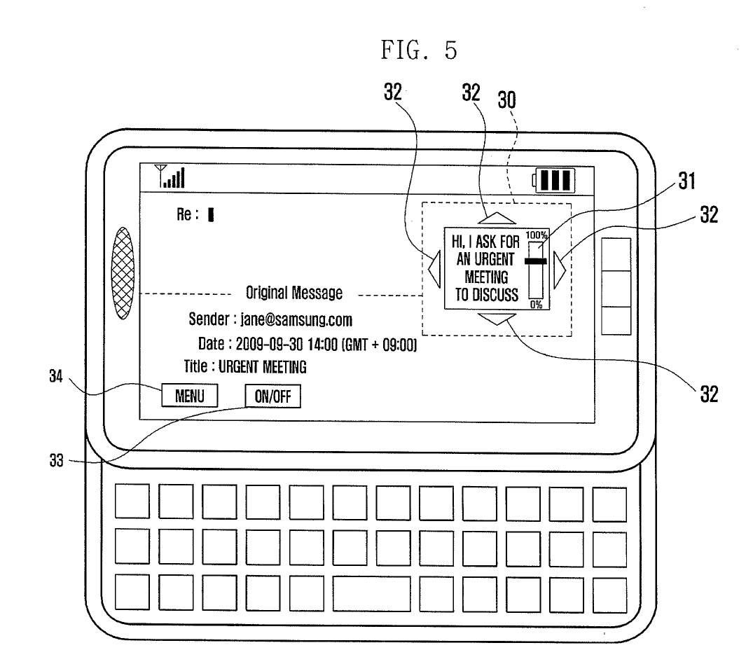

FIG. 4 is a flow diagram illustrating a method for displaying a reply page to a received e-mail in a mobile device according to an exemplary embodiment of the present invention, and FIG. 5 shows example screen views related to the method shown in FIG. 4.

Referring to FIGS. 4 and 5, the mobile device 100 is available for a landscape mode (i.e., a widthwise view mode), has the input unit 140 with a qwerty key layout, and has the display unit 130 formed of a touch screen, as shown in FIG. 5. Exemplary embodiments of the present invention are, however, not limited to the example shown in FIG. 5.

The control unit 110 is in an idle state in step 401. The control unit 110 outputs a received e-mail (hereinafter, also referred to as an original e-mail) in the display unit 130 in response to a given input signal (e.g., a selection signal of a specific received e-mail) from the input unit 140 in step 403, or upon receipt of the received e-mail.

The control unit 110 determines whether there is a request for a reply to the original e-mail in step 405. If there is no request for a reply, the control unit 110 may perform another requested or predefined function in step 417. For example, the control unit 110 may delete the original e-mail when receiving a delete command for the original e-mail, or output a new page for inputting user information (e.g., an e-mail address) of a recipient when receiving a forward command. If there is a request for a reply in step 405, the control unit 110 outputs a reply page to a received e-mail in the display unit 130 in step 407 and also outputs the floating window 30 containing the original e-mail on the reply page in overlay form in step 409. The control unit 110 may convert the original e-mail into a suitable format for the floating window 30 with a relatively smaller size. For example, the control unit 110 may perform a font size modification and a rearrangement of the original e-mail via a conversion program stored in the memory unit 120.

Referring to FIG. 5, the floating window 30 may have the transparency adjust bar 31 and the scroll keys 32. The on/off key 33 and the menu key 34 may be displayed in the display unit 130, as previously described with reference to FIG. 3. While writing a reply e-mail, the user may scroll a screen view in the floating window 30 through the scroll keys 32 and may move the floating window 30 through a touch and drag action in a desired direction. The user may adjust the transparency of the floating window 30 via the transparency adjust bar 31 and may remove the floating window 30 from the display unit 130 via the on/off key 33 if the floating window 30 is not needed any more.

The control unit 110 may output a given phrase such as ‘Re:’ in connection with a reply page. The control unit 110 may further output a sender, date, title and details of the original e-mail in a portion of a reply page. As shown in FIG. 5, the display unit 130 may often fail to entirely output the original e-mail, especially if the display unit 130 adopts a landscape mode. In this case, the user may need to scroll frequently in order to see details of the original e-mail while writing a reply e-mail. However, since the floating window 30 shows the reply simultaneously with the original e-mail in overlay form, the need for a frequent scroll is reduced, thereby improving user's experience.

Returning to FIG. 4, the control unit 110 determines whether a signal indicating the completion of a reply e-mail is received from the input unit 140 in step 411. If no completion signal is received, the control unit 110 may return to step 407. If the completion signal for a reply e-mail is received from the input unit 140, the control unit 110 sends the reply e-mail to a recipient, namely a sender of the original e-mail, through the RF unit 150 in step 413. If the mobile device 100 has a wireless LAN module therein, the control unit 110 may send the reply e-mail to a recipient through the wireless LAN module.

The control unit 110 determines whether a signal indicating the end of an e-mail menu is received from the input unit 140 in step 415. If no end signal is received, the control unit 110 may perform another requested or predefined function in step 417. For example, the control unit 110 may output a list of received e-mails and then, depending on the user's selection, delete some received e-mail from the list or output a new reply page to a received e-mail. If an end signal for an e-mail menu is received from the input unit 140, the control unit 110 ends the e-mail menu and returns to an idle state.

As fully discussed hereinbefore, exemplary embodiments of the present invention are characterized by outputting a limited portion of certain content in the display unit 130 and simultaneously outputting another portion or other content in the floating window 30 on the display unit 130 in overlay form.

Since the mobile device outputs a received original message in the floating window 30 offered in overlay form on a page for writing a reply message, the user can easily write a reply message while seeing a received original message. Additionally, when displaying a web page with a relatively higher screen resolution, the mobile device outputs a limited portion of a web page in the display unit 130 and also output other portion in the floating window 30. Accordingly, the user can easily see the entire web page without unnecessary scroll actions, thereby improving the user's experience.

While the invention has been shown and described with reference to certain exemplary embodiment thereof, it will be understood by those skilled in the art that various changes in form and details may be made therein without departing from the spirit and scope of the invention as defined by the appended claims and their equivalents.

What is claimed is:

1. A method for displaying content in a mobile device, the method comprising:
outputting a first portion of the content in a display unit; and
simultaneously outputting a second portion of the content or other content linked to the content in a floating window selectively offered on the display unit in overlay form.

2. The method of claim 1, wherein the content includes a reply to a received message, a reply to a received e-mail, an instant messenger service, a web page, and a document.

3. The method of claim 2, wherein the outputting of the second portion in the floating window includes at least one of:
outputting the received message in the floating window when the content is the reply to the received message;
outputting the received e-mail in the floating window when the content is the reply to the received e-mail;
outputting a preceding or following page of a current page in the floating window when the content is the document and when the display unit outputs the current page of the document;
outputting a past dialog of a current chat room or other chat room in the floating window when the content is the instant messenger service and when the display unit outputs the current chat room; and
outputting a second portion of a web page in the floating window when the content is the web page and when the display unit outputs a first portion of the web page.

4. The method of claim 1, wherein the outputting of the second portion in the floating window includes at least one of:
creating a thumbnail of the second portion of the content or the other content and then outputting the thumbnail in the floating window; and
extracting text information from the second portion of the content or the other content, performing at least one of a font size modification and a rearrangement in the text information, and then outputting the text information in the floating window.

5. The method of claim 1, further comprising at least one of:
moving the floating window in a specific direction in response to a touch and drag signal on the floating window or in response to a navigation key signal received from an input unit after instructions to move the floating window;
adjusting a transparency of the floating window in response to a touch and drag signal received from a transparency adjust bar or in response to a volume key signal received from the input unit;
scrolling a screen view in the floating window in response to a touch signal received from a scroll key or in response to a navigation key signal received from the input unit after the floating window is selected; and
controlling a display of the floating window in response to a touch toggle signal received from an on/off key or in response to a given function key signal received from the input unit.

6. A mobile device comprising:
a display unit for displaying a first portion of content; and
a control unit for outputting the first portion of the content in the display unit and for simultaneously outputting a second portion of the content or other content linked to the content in a floating window selectively offered on the display unit in overlay form.

7. The mobile device of claim 6, wherein the floating window includes at least one of a transparency adjust bar for adjusting transparency of the floating window and a scroll key for moving a screen view in the floating window.

8. The mobile device of claim 6, wherein the display unit displays an on/off key for controlling the display of the floating window.

9. The mobile device of claim 6, wherein the control unit moves the floating window in a specific direction in response to a touch and drag signal on the floating window.

10. The mobile device of claim 6, wherein the control unit outputs a received message in the floating window when the content is a reply to the received message.

11. The mobile device of claim 6, wherein the control unit outputs a received e-mail in the floating window when the content is a reply to the received e-mail.

12. The mobile device of claim 6, wherein the control unit outputs a preceding or following page of a current page in the floating window when the content is a document and when the display unit outputs the current page of the document.

13. The mobile device of claim 6, wherein the control unit outputs a past dialog of a current chat room or other chat room in the floating window when the content is an instant messenger service and when the display unit outputs the current chat room.

14. The mobile device of claim 6, wherein the control unit outputs a second portion of a web page in the floating window when the content is the web page and when the display unit outputs a first portion of the web page.

15. The mobile device of claim 6, wherein the control unit creates a thumbnail of the second portion of the content or the other content and then outputs the thumbnail in the floating window, or extracts text information from the second portion of the content or the other content, performs at least one of a font size modification and a rearrangement in the text information, and then outputs the text information in the floating window.

16. A method of displaying content in a mobile device, the method comprising:
receiving first content;
displaying the first content on a display unit of the mobile device; and
simultaneously with the display of the first content, displaying second content in an overlay window overlaying the first content,
wherein the second content is a portion of the first content not otherwise displayed on the display unit, or is content related to the first content.

17. The method of claim 16, wherein the display unit further displays touch-sensitive controls for controlling the overlay window and/or the second content.
